(19) United States
(12) Patent Application Publication
(10) Pub. No.: US 2010/0163342 A1
(43) Pub. Date: Jul. 1, 2010

(54) FOLDABLE TRESTLE

(76) Inventor: Pierre Rondreux, La Norville (FR)

Correspondence Address: KENYON & KENYON LLP, 1500 K STREET N.W., SUITE 700, WASHINGTON, DC, 20005, US

(21) Appl. No.: 12/293,750

(22) PCT Filed: Mar. 20, 2007
(86) PCT No.: PCT/FR07/50956

§ 371 Date: Feb. 18, 2009

(30) Foreign Application Priority Data
Mar. 20, 2006 (FR) 0602402
Sep. 8, 2006 (FR) 0653640

(51) Int. Cl. B25H 1/06; A47B 3/091

(52) U.S. Cl. 182/155

(57) ABSTRACT

The invention relates to a folding trestle having a folded position and a deployed position, said trestle comprising: a crossbeam having a longitudinal dimension and a transverse dimension that define a bottom face; first and second pairs of legs; and hinge mechanisms enabling the legs of each of the pairs of legs to be spaced apart from each other when the trestle is in the deployed position, and to extend against each other when the trestle is in the folded position, the hinge mechanisms also enabling each of the pairs of legs to pivot about a respective axis that is transverse to the crossbeam so that, in the folded position, the pairs of legs extend under said bottom face of the crossbeam. The invention is characterized in that the trestle further comprises a first locking device connecting one side of one of the legs of at least one of the pairs of legs to the crossbeam in order to lock said pair of legs in the deployed position relative to the crossbeam.

This is a 371 national phase application of PCT/FR2007/050956 filed 20 Mar. 2007, claiming priority to French Patent Application No. 0602402 filed 20 Mar. 2006, and No. 0653640 filed 8 Sep. 2006, respectively, the contents of which are incorporated herein by reference.

### FIELD OF THE INVENTION

The present invention relates to the field of portable support devices such as trestles or sawhorses, for example.

The present invention relates more particularly to a folding trestle having a folded position and a deployed position, said trestle comprising: a crossbeam having a longitudinal dimension and a transverse dimension that define a bottom face; and first and second pairs of legs fastened to respective ones of the two opposite ends of the crossbeam, via respective ones of first and second hinge means, the hinge means enabling the legs of each of the pairs of legs to be spaced apart from each other when the trestle is in the deployed position, and to extend against each other when the trestle is in the folded position, the hinge means also enabling each of the pairs of legs to pivot about a respective axis that is transverse to the crossbeam so that, in the folded position, the pairs of legs extend under said bottom face of the crossbeam.

### BACKGROUND OF THE INVENTION

Document U.S. Pat. No. 4,880,080 describes such a folding trestle in which the crossbeam has a hollow inside and is channel-section in shape so that, when it is in the folded position, the pairs of legs fit inside the crossbeam.

More precisely, the legs of the first pair are fastened to the web of the channel-section crossbeam whereas the legs of the second pair are fastened some distance from the web.

Therefore, the legs of the first pair are necessarily longer than the legs of the second pair so as to compensate for the fact that the pairs of legs are not both fastened to the web of the crossbeam.

Thus, in order to fold that trestle away, firstly the legs of the first pair are folded away, touching each other and against the web of the crossbeam, and then the legs of the second pair are folded away, touching each other and against the first pair of legs so that, in the folded position, both pairs of legs fit inside the hollow inside of the crossbeam.

That trestle suffers from the drawback of requiring legs of different lengths to be manufactured, and therefore the cost of manufacturing such a trestle is high. In addition, in order to fold the trestle away, the user must follow a particular sequence, by folding away the first pair of legs first.

Another drawback of that trestle is that the transverse compactness obtained by the fact that the pairs of legs are positioned one on the other inside the crossbeam is achieved to the detriment of the bearing surface area of the trestle, i.e. to the detriment of the area for supporting an object, such as a plank, for example.

Document U.S. Pat. No. 3,233,701 discloses a trestle provided with two pairs of legs that are fastened to a crossbeam via hinge devices that are offset transversely relative to each other so that, in the folded position, the first and second pairs of legs extend side-by-side along said bottom face of the crossbeam.

In that trestle, stability is secured by the two hinge devices, each of which has two divergent side plates against which the legs of a respective pair of legs come to bear when the trestle is in the deployed position, as can be seen in FIG. 3 of that document.

In the folded position, those side plates are very voluminous because they project from the bottom face of the crossbeam at either end thereof, and can injure a person carrying the trestle.

### SUMMARY OF THE INVENTION

An object of the present invention is to remedy those drawbacks by providing a trestle that has good stability while also being compact when it is in the folded position.

This object is achieved by the fact that the trestle of the invention further comprises first locking means connecting one side of one of the legs of at least one of the pairs of legs to the crossbeam in order to lock said pair of legs in the deployed position relative to the crossbeam.

The term “connecting” is used to mean that the first locking means are fastened both to the side of said leg and to the crossbeam, optionally via an intermediate part.

Advantageously, the first locking means connect a side edge of the crossbeam to that leg of said pair that is closer to said side edge.

Thus, in the deployed position, that leg of the pair of legs that is closer to the side edge of the crossbeam is held stationery relative to the crossbeam in direct manner, thereby enabling the trestle to present good stability, or at least better stability than if the leg were held stationary via the hinge device proposed by the above-mentioned prior art document.

Advantageously, the first locking means comprise a scissors-type pair of links.

Preferably, the pair of links comprises a first link fastened to the side edge of said leg and a second link fastened to the side edge of the crossbeam, the first and second links being hinged together.

In an advantageous variant, the trestle of the invention further comprises second locking means connecting one side of the other leg of said pair of legs to the crossbeam.

An advantage of said second locking means is that they further improve the stability of the pair of legs when the trestle is in the deployed position.

Preferably, said side of the other leg is the side that is closer to the other pair of legs.

Preferably, the second locking means comprise a scissors-type pair of links.

In particularly advantageous manner, the trestle of the invention further comprises a bracket that is secured to the bottom face of the crossbeam, said bracket having a first end fastened to the first locking means and a second end fastened to the second locking means.

Preferably, the bracket extends transversely relative to the crossbeam and includes projecting portions that are disposed at respective ones of its first and second ends, the length of the bracket being substantially equal to the thickness of the two legs of said pair so that, in the folded position, the pair of legs is flanked by said portions of the bracket.

One advantage is that the pair of legs is held transversely when the trestle is in the folded position.

In addition, it can be understood that, in the folded position, the legs of the trestle are transversely aligned against one another so that trestle of the invention offers the advantage of being compact in the thickness direction of the crossbeam, rather than in the transverse direction, and therefore the compactness that is achieved is not achieved to the detriment of the area of the bearing surface.

On the contrary, the trestle of the invention can present a bearing surface area that is larger than that of the above-mentioned known trestle, thereby imparting greater stability to the trestle and enabling it to bear larger loads.

In a preferred manner, the pairs of legs are offset transversely relative to each other, thereby making the pairs of legs suitable for being juxtaposed to each other when the trestle is in the folded position.

Advantageously, each of the legs of the two pairs of legs presents a thickness extending perpendicular to the longitudinal direction of the crossbeam, and the sum of the thicknesses of the legs of both pairs is substantially equal to the width of the crossbeam.

Thus, in the folded position, the trestle offers the advantage of presenting a transverse overall size substantially equal to the width of the crossbeam, and a longitudinal overall size substantially equal to the length of the crossbeam.

In particularly advantageous manner, the trestle presents an overall size in the thickness direction that is substantially equal to the sum of the thickness of the crossbeam and of the width of one of the legs.

The trestle of the invention is thus much more compact than the above-mentioned prior art trestle because it does not require hinge devices that project from either end of the crossbeam.

Thus, in the folded position, the legs do not project beyond the crossbeam either in its longitudinal direction or in its transverse direction.

In accordance with the invention, the first locking means can be constituted by a single pair of links because the two legs of the same pair pivot together about the axis transverse to the crossbeam.

Advantageously, the trestle of the invention further comprises at least one scissors-type pair of links for holding the legs of at least one of the pairs of legs spaced apart when the trestle is in the deployed position.

In the meaning of the invention, a “pair of links” is a scissors-type coupling part made up of two links that are hinged together, it being possible for said part to present a deployed position and a folded position.

Preferably, all of the pairs of links used in the trestle of the invention are of the type in which, in the folded position, the links are disposed edge against edge, so that they extend substantially in the same plane. Preferably, over their lengths, the links present embossing that makes it possible to stiffen the pair of links.

Thus, when the trestle is in the deployed position, at least one of the pairs of legs, and preferably both of them, is/are held stationary relative to the crossbeam by the fact that one of the legs of said pair is held stationary relative to the crossbeam by means of the first locking means and thus enables the other leg to be held stationary by means of the pair of links that holds them spaced apart.

In a first embodiment of the invention, at least one of the first and second hinge means comprises first and second plates suitable for pivoting relative to each other, the first plate being fastened to the bottom face of the crossbeam while the second plate is provided with two side plates that can pivot in a plane defined by said second plate, each of the two side plates being fastened to a respective one of the two legs of said pair.

It can be understood that the side plates advantageously make it possible to move with the legs as they pivot.

Preferably, the second plate is further provided with abutment means for limiting the pivoting of the two side plates.

These abutment means make it possible to prevent the pair of legs from pivoting when the legs of said pair are mutually touching and side-by-side.

In a second embodiment of the invention, at least one of the first and second hinge means comprises first and second plates suitable for pivoting relative to each other, the first plate being fastened to the bottom face of the crossbeam, the two legs are mounted to pivot on the second plate, and the second plate is provided with guide means for guiding the pivoting of the two legs in the plane of the second plate.

Advantageously, the guide means comprise two oblong slots, and each of the two legs is provided with a lug co-operating with a respective one of the two slots.

Preferably, the lug is constituted by a screw.

Preferably, the slots are rectilinear and can present clearance relative to the lugs so as to compensate for the curvature of the paths of said lugs while the legs of the trestle are going from one position to the other.

In a third embodiment of the invention, at least one of the first and second hinge means comprises an arm suitable for pivoting about an axis that is transverse to the crossbeam, while, in the deployed position, the arm is inserted into a groove provided in the bottom face of the crossbeam, while also extending longitudinally relative thereto, and said hinge means further comprises two side plates to which the legs are fastened, the two side plates being suitable for pivoting about an axis extending longitudinally relative to the arm.

The object of the invention is also achieved by the fact that at least one of the legs of one of the two pairs of legs presents an end that is beveled so that, in the deployed position, said end comes into abutment against said bottom face of the crossbeam so as to improve the stability of the trestle.

Advantageously, the trestle further comprises first locking means and preferably second locking means that are similar to those defined above.

### BRIEF DESCRIPTION OF THE DRAWINGS

The invention can be well understood and its advantages appear more clearly on reading the following description of embodiments indicated by way of non-limiting example. The description refers to the accompanying drawings, in which:

FIG. 1 is a face view of the trestle of the invention, in the deployed position;

FIG. 2 is an end view of the trestle of the invention in the deployed position;

FIG. 3 is a face view of the trestle of the invention in the folded position;

FIG. 4 is an end view of the trestle of the invention in the folded position;

FIG. 5 is a perspective view of the trestle of the invention in the deployed position;

FIG. 6 is an exploded perspective view of a first embodiment of the hinge means of the invention;

FIG. 7 is a face view of the first embodiment of the hinge means of the invention, showing the side plates in the spaced-apart position;

FIG. 8 is an exploded perspective view of a second embodiment of the hinge means of the invention;

FIG. 9 is a perspective view showing how the hinge means of FIG. 8 are fastened to the crossbeam, and to the legs of one of the pairs of legs;

FIG. 10 is a face view of the second embodiment of the hinge means of the invention, showing the position of the legs of one of the pairs when they are touching each other side-by-side;

FIG. 11 is a face view of the second embodiment of the hinge means of the invention, showing the position of the legs of one of the pairs when they are spaced apart from each other;

FIG. 12 is a side view of a third embodiment of the hinge means of the invention, showing the side plates spaced apart from each other;

FIG. 13 is a side view of the third embodiment of the hinge means of the invention, showing the side plates extending along the abutment-forming blade;

FIG. 14 is a perspective view of the third embodiment of the hinge means of the invention, showing the side plates spaced apart from each other; and

FIG. 15 is a perspective view of the hinge means and of the locking means in a variant of the invention, shown when the trestle is in the deployed position.

### DETAILED DESCRIPTION

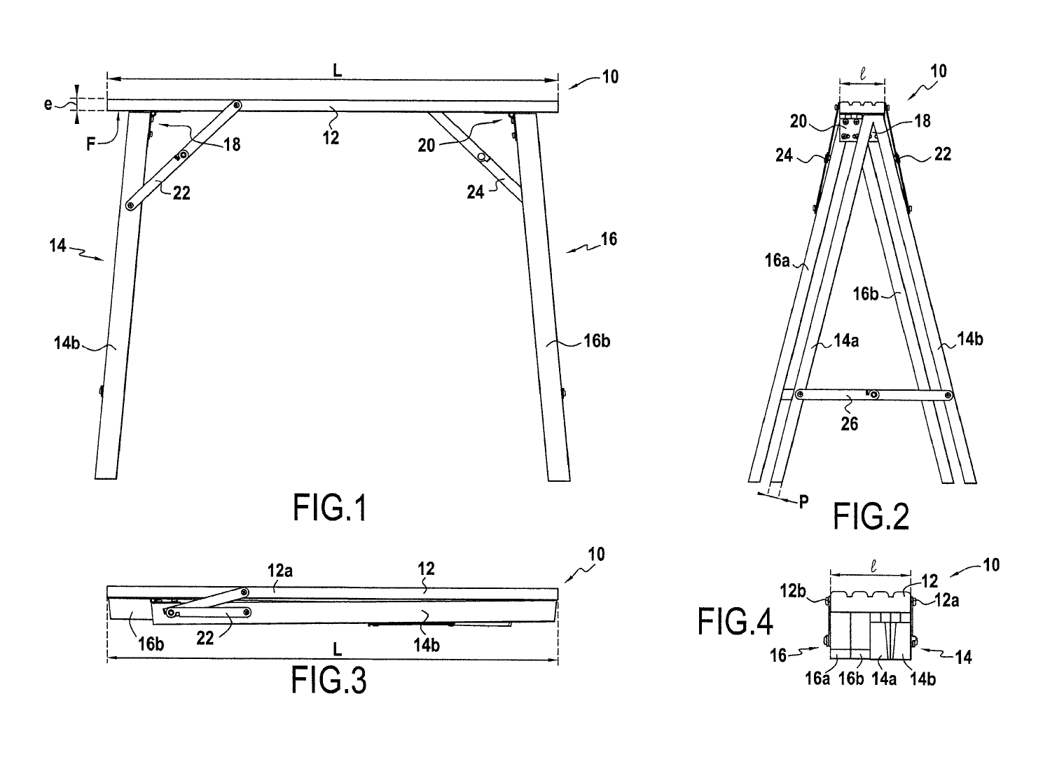

Firstly, a folding trestle 10 of the present invention is described below with reference to FIGS. 1 to 5.

The trestle 10 of the present invention is preferably made of wood, although it is quite possible to use other materials such as metal, plastic, or some other material that is suitable for this purpose.

In addition, the folding trestle 10 offers the advantage of being compact when it is in the folded position while also being particularly stable when it is in the deployed position.

The trestle 10 includes a crossbeam 12 of the bearing crossbeam type having a longitudinal dimension L, a transverse dimension l, and a thickness e.

In the description below, unless otherwise indicated, the terms “longitudinally” and “transversely” refer respectively to the longitudinal dimension L and to the transverse dimension l of the crossbeam 12.

By way of non-limiting example, the length L of the crossbeam lies in the range 500 millimeters (mm) to 1200 mm, and is preferably 790 mm, the width l of the crossbeam lies in the range 80 mm to 120 mm, and is preferably 90 mm, while the thickness e lies in the range 20 mm to 40 mm, and is preferably 25 mm.

The longitudinal dimension L and the transverse dimension l define a bottom face F that is substantially, but not necessarily, rectangular in shape.

Preferably, but not necessarily, the crossbeam is provided with longitudinal grooves on its top face, so as to prevent the object that is to be supported by the trestle from slipping on the crossbeam.

The trestle 10 further includes a first pair of legs and a second pair of legs respectively referenced 14 and 16.

The legs of the first pair are referenced 14a, 14b, while the legs of the second pair are referenced 16a, 16b.

As can be seen in FIG. 1, the first and second pairs of legs 14, 16 are fastened to respective ones of the two opposite longitudinal ends of the bottom face F of the crossbeam 12 via respective ones of the first and second hinge means 18, 20.

In this example, the hinge means 18, 20 are in the form of hinges and they enable the legs 14a, 14b, 16a, 16b of each of the pairs 14, 16 to be spaced apart from each other when the trestle is in the deployed position as shown in FIGS. 1, 2, and 5, and to extend against each other when the trestle is in the folded position as shown in FIGS. 3 and 4.

The hinge means also enable each of the pairs of legs 14, 16 to pivot about a respective axis that is transverse to the crossbeam so that, in the folded position, as shown in FIGS. 3 and 4, the pairs of legs 14, 16 extend under the bottom face F of the crossbeam 12.

These hinge means 18, 20 are described in more detail below.

In particularly advantageous manner, the hinge means 18, and the pairs of legs 14, 16 are offset transversely relative to each other, as shown in FIGS. 2 and 4.

In other words, the first hinge means 18 are disposed in the vicinity of a first side edge 12a of the crossbeam, while the second hinge means 20 are disposed in the vicinity of a second side edge 12b of the crossbeam that is opposite from the first side edge 12a.

It can be understood that, in order to fold the trestle starting from the deployed position, the legs of each of the pairs 14, 16 are brought together, and then the pairs of legs 14, 16 are caused to pivot so as to bring them under the bottom face F of the crossbeam.

As can be understood from FIG. 4, the transverse offset of the hinge means 18, 20 and thus of the pairs of legs 14, 16, enables said pairs of legs to extend side-by-side along the bottom face F of the crossbeam 12.

It can thus be understood that the two legs 14a, 14b of the first pair 14 are disposed alongside the two legs 16a, 16b of the second pair 16.

Thus, in the folded position, the four legs 14b, 14a, 16b and 16a of the trestle are disposed side-by-side, edge-against-edge, firstly the legs of one of the pairs of legs and then the legs of the other pair of legs, so that the transverse overall size of the pairs of legs is substantially equal to the sum of the thicknesses p of the legs 14a, 14b, 16a, 16b, the thickness p being the dimension of the legs that is considered in a direction orthogonal to the longitudinal direction of the crossbeam 12.

Preferably, provision is made for the width l of the crossbeam 12 to be substantially equal to the transverse overall size of the two pairs of legs when the trestle 10 is in the folded position, as can be seen clearly in FIG. 4, and the bearing surface area of the trestle 10 is thereby advantageously larger than the bearing surface area of the known trestle as described above.

In addition, by means of FIG. 4, it can be understood that, in the folded position, the overall size of the trestle 10 in a direction orthogonal to the bottom surface F corresponds to the sum of the thickness e of the crossbeam 12 and of the width of one of the legs, and the overall size in said direction is thereby advantageously smaller than for the above-described known trestle.

As can be seen in FIG. 2, those ends of the legs 14a, 14b, 16a, and 16b that are closer to the crossbeam 12 are, in a first advantageous aspect of the invention, beveled so that, in the folded position, the face that is situated at that end of one of the legs that is close to the crossbeam is parallel to the bottom surface F while also coming into contact therewith, so that the forces exerted on the crossbeam are taken up directly by the legs and not via the hinge means 18, 20, so as to improve the stability of the trestle 10 further.

In order to lock the pairs of legs 14, 16 in the deployed position, and in a second advantageous aspect of the invention that is independent of the first aspect, the trestle 10 is provided with two first locking means 22, 24, each of the first locking means 22, 24 connecting at least one of the legs of each of the pairs to the crossbeam 12. Preferably, each of the first locking means 22, 24 comprises a scissors-type pair of links.

In the variant shown in FIG. 1, the first locking means 22, 24 comprise first and second pairs of links that connect those sides of the respective legs of the pairs of legs that are closest to respective ones of the two side edges 12a, 12b of the crossbeam to respective ones of said side edges.

Thus, the first pair of links 22 connects the leg 14b to the first side edge 12a of the crossbeam 12, while the second pair of links 24 connects the leg 16a to the second side edge 12b of the crossbeam 12.

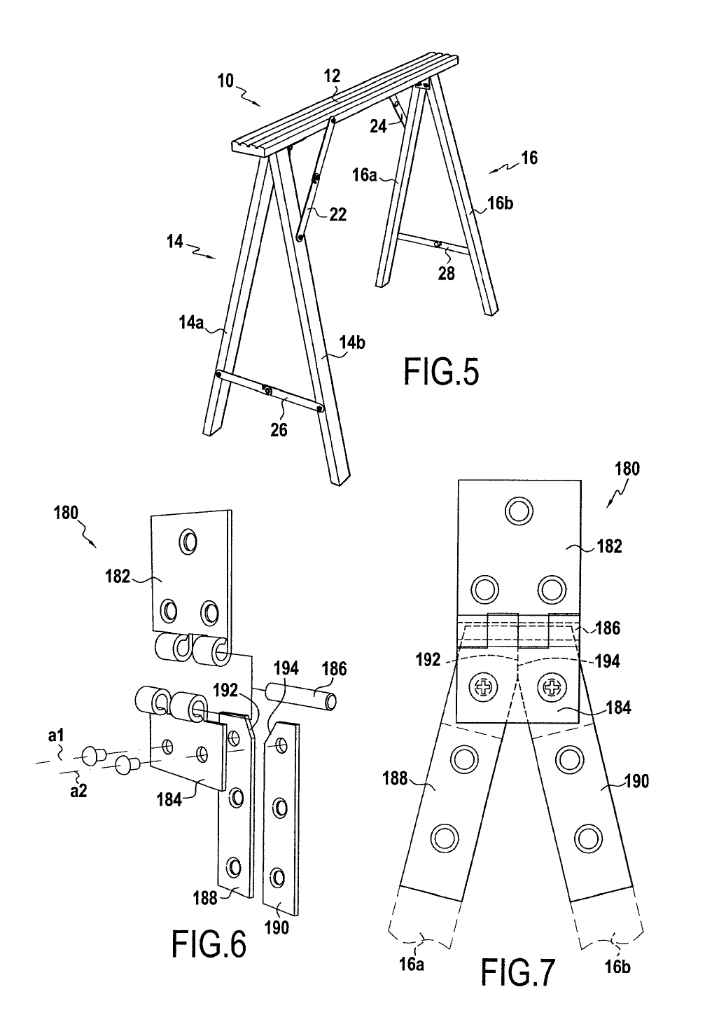

As can be understood from FIGS. 1 and 5, the pairs of links 22 and 24 serve to prevent the pairs of legs 14, 16 from pivoting when the trestle 10 is in the deployed position.

In addition, the pairs of links 22, 24 are designed to be capable of absorbing a small amount of bending due to the legs to which they are fastened being spaced apart.

The trestle 10 of the present invention is also provided with third and fourth pairs of links 26, 28 that can be seen more particularly in FIG. 5 and that make it possible to keep the legs of each of the two pairs 14, 16 apart when the trestle 10 is in the deployed position.

In a particularly advantageous manner, the first, second, third, and fourth pairs of links are identical so that the number of types of parts necessary for manufacturing the trestle 10 is further reduced, thereby further simplifying manufacturing of the trestle.

Various embodiments of the hinge means 18, 20 of the folding trestle 10 of the present invention are described in more detail below.

FIGS. 6 and 7 show a first embodiment of hinge means 180 of the invention.

These hinge means 180 are in the form of a hinge 180 that comprises a first plate 182 designed to be fastened parallel to the bottom face F of the crossbeam, a second plate 184 united with the first plate 182 by means of a pin 186 so that the first and second plates 182, 184 are suitable for pivoting relative to each other.

It can be understood that the hinge 180 is fastened to the crossbeam 12, preferably by screws, so that the first and second plates 182, 184 can pivot relative to each other about an axis that is transverse to the crossbeam 12.

The hinge 182 further comprises two side plates 188, 190 extending in much the same plane as the second plate 184 while also being capable of pivoting about two axes a1, a2 that are orthogonal to the plane of the second plate 184, i.e. the side plates 188, 190 can pivot in a plane parallel to the plane of the second plate 184.

As can be seen in FIGS. 6 and 7, the two side plates 188, 190 are symmetrical about a plane orthogonal to the axis of the pin 186.

The side plates 188, 190 are designed to be fastened to the legs of one of the pairs 14, 16 so as to pivot with said legs as said legs pivot relative to each other.

Each of the two side plates 188, 190 has an end close to the pin 186, which end preferably presents a bevel 192, 194.

With reference to FIG. 7, it can be understood that the bevels 192, 194 are suitable for coming into contact with each other when the two side plates 188, 190 are spaced apart from each other, thereby advantageously limiting the relative spacing of the side plates 188, 190 and more particularly the relative spacing of the legs.

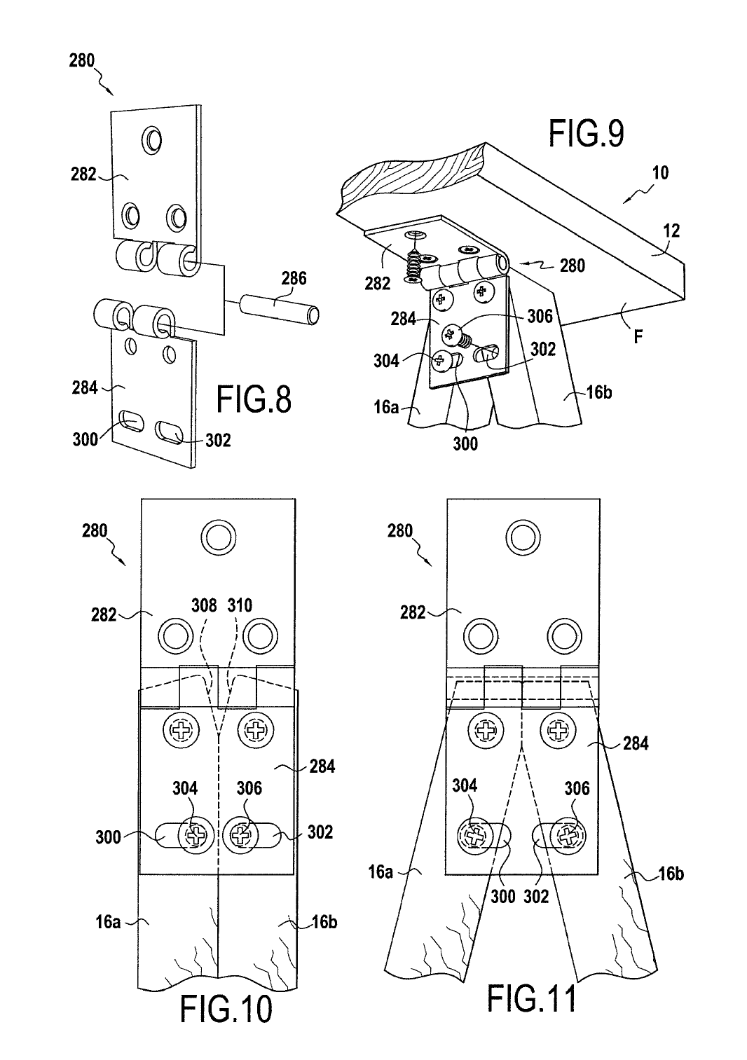

FIGS. 8 to 11 show a second embodiment of the hinge means 280 of the invention.

These hinge means 280 are in the form of a hinge 280 similar to the hinge of the first embodiment, except that the hinge 280 of the second embodiment is not provided with side plates.

The elements of the second embodiment that are similar to the elements of the first embodiment bear like numerical references plus one hundred.

As can be seen in FIG. 9, the first plate 282 is fastened to the bottom face F of the crossbeam 12, preferably by screws, while the legs 16a, 16b of the second pair of legs 16 are mounted to pivot on the second plate 284. Naturally, another hinge similar to the hinge 282 is also provided so as to enable the first pair of legs 14 to be hinged.

More precisely, the legs 16a, 16b can pivot about axes orthogonal to the second plate 284 that are disposed at that end of said second plate that is close to the pin 286.

In addition, the second plate 284 is further provided with guide means that are in the form of two preferably rectangular oblong slots 300, 302, each of which movably receives a lug 304, 306 that is fastened a respective one of the two legs 16a, 16b.

It can be understood that the oblong slots 300, 302 present clearance relative to the lugs 304, 306 so as to compensate for them moving along curved paths.

It can be understood by means of FIGS. 10 and 11 that the oblong slots also make it possible to limit the extent to which the legs 16a, 16b can be spaced apart.

Preferably, the oblong slots are dimensioned so as advantageously to limit the extent to which the legs 16a, 16b can move as they open and as they close.

Preferably, each of the ends of the legs 16a, 16b that are close to the pin 286 further presents a bevel 308, 310, the two bevels being suitable for coming into contact with each other when the trestle 10 is in the deployed position, as shown in FIG. 11, in order to improve the stability of the trestle and in order to limit the spacing between the legs 16a, 16b.

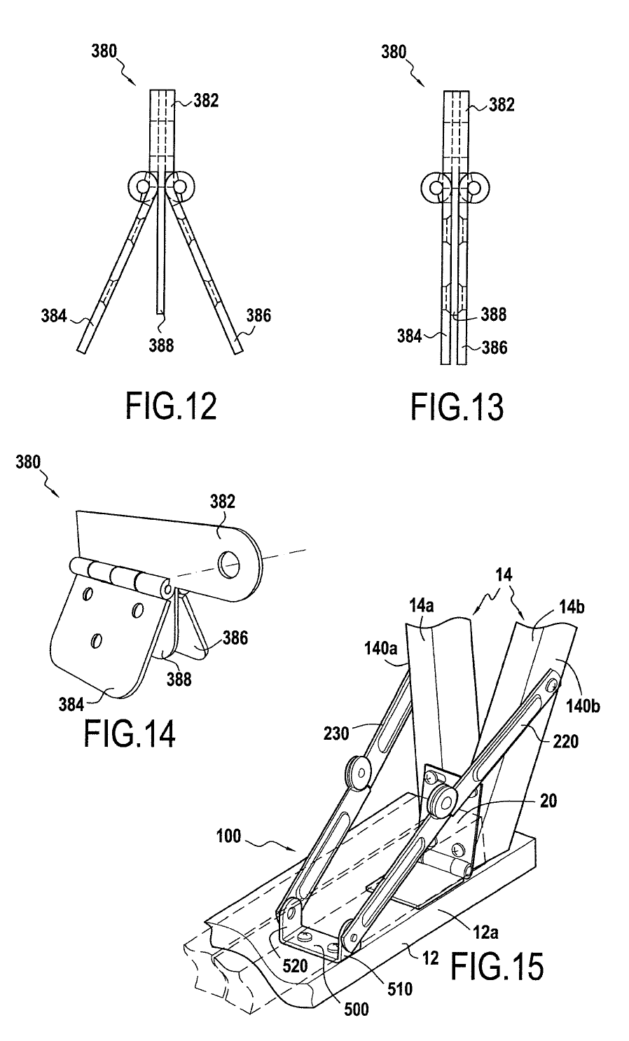

FIGS. 12 to 14 show a third embodiment of the hinge means 380 of the invention.

These hinge means 380 are also in the form of a hinge. This hinge is provided with an arm 382 which, at one of its two ends, is provided with a hole for enabling it to pivot about an axis that is transverse to the crossbeam.

The arm 382 is also designed to be inserted into a groove provided in the bottom face F of the crossbeam 12 when the trestle is in the deployed position, said groove extending in the longitudinal direction of the crossbeam 12.

As can be seen in FIGS. 12 and 14, the hinge 380 is further provided with two side plates 384, 386 to which the legs of one of the pairs of legs (not shown) are fastened, the two side plates being suitable for pivoting about an axis extending longitudinally relative to the arm 282.

The hinge 380 is further provided with an abutment-forming blade 388 that is fastened to the arm 382 while also being disposed between the two side plates 384, 386.

FIG. 12 shows the hinge 382 when the side plates 384, 386 are spaced apart from each other, while FIG. 13 shows the hinge in a position in which the side plates 384, 386 extend against the blade 388. It can be understood that said blade 388 advantageously makes it possible to hold the pair of legs when the trestle is in the folded position.

Preferably, the folding trestle 10 of the invention is further provided with means for holding the trestle in the folded position, which means comprise, for example, at least one hook fastened to one of the side edges 12a, 12b of the crossbeam 12 and designed to engage with a lug fastened to one of the legs.

FIG. 15 shows an advantageous variant of the trestle 100 and more precisely how one of the pairs 14 of legs and the crossbeam 12 are assembled together, the other pair 16 of legs and the crossbeam 12 advantageously being assembled together in similar manner.

In this variant, the trestle 100 is provided with first locking means 220 connecting the crossbeam 12 to a side 140b of the leg 14b that is closer to the side edge 12a, it being recalled that said side edge 12a is the side edge that is closer to the pair of legs 14.

As can be seen in FIG. 15, the first locking means 220 are fastened to the crossbeam preferably via a bracket 500 that is secured to the bottom face F of the crossbeam 12.

In addition, the bracket 500 is preferably situated between the two pairs of legs 14, 16.

Said bracket 500, which extends in the transverse direction of the crossbeam 12, is in the general shape of a strip whose first and second ends 510, 520 are folded back to form a U-shape, i.e. the first and second ends 510, 520 are projecting portions that extend substantially in planes orthogonal to the bottom face F of the crossbeam 12.

In the meaning of the invention, the first end 510 of the bracket 500 is the end that is closer to the side edge 12a.

Preferably, the first end 510 extends substantially in a plane of the side edge 12a of the crossbeam 12.

Advantageously, the first locking means 220 are fastened to the first end 510 of the bracket 500.

In this advantageous variant, the trestle 100 is further provided with second locking means 230 that connect the crossbeam 12 to a side 140a of the leg 14a of the pair 14 that is further from the side edge 12a of the crossbeam 12.

In other words, the first and second locking means 220, 230 flank the pair of legs 14.

Preferably, the second locking means 230 are fastened to the second end 520 of the bracket 500 as shown in FIG. 15.

The presence of the second locking means 220, 230 makes it possible to hold the pair of legs 14 in improved manner when the trestle 100 is in the deployed position.

Preferably, the first and second locking means 510, 520 are hinged pairs of links whose links are suitable for being folded together against each other when the trestle is in the folded position, the links forming an angle of 180° when the trestle is in the deployed position.

As can be seen in FIG. 12, the hinged pairs of links 510, 520 are designed to be capable of absorbing a small amount of bending when the legs 14a, 14b to which they are fastened are spaced apart.

Advantageously, the length of the bracket 500 is substantially equal to or slightly greater than the cumulative thickness of the two legs 14a, 14b so that, in the folded position, the pair of legs 14, shown in dashed lines in FIG. 15, is flanked by the projecting portions 510, 520.

It can be understood that the pair of legs 14 is thereby advantageously held transversely when the trestle is in the folded position.

In this variant, the ends of the legs 14a, 14b that are situated closer to the crossbeam 12 are preferably but not necessarily beveled so that, in the deployed position, said ends come into abutment against the bottom face F of the crossbeam 12, so as to improve the stability of the trestle 100 further.

1.-29. (canceled)

30. A folding trestle having a folded position and a deployed position, said trestle comprising: a crossbeam having a longitudinal dimension and a transverse dimension that define a bottom face; and first and second pairs of legs fastened to respective ones of the two opposite ends of the crossbeam, via respective ones of first and second hinge mechanisms, the hinge mechanisms enabling the legs of each of the pairs of legs to be spaced apart from each other when the trestle is in the deployed position, and to extend against each other when the trestle is in the folded position, the hinge mechanisms also enabling each of the pairs of legs to pivot about a respective axis that is transverse to the crossbeam so that, in the folded position, the pairs of legs extend under said bottom face of the crossbeam, the first and second hinge mechanisms being offset transversely relative to each other, so that, in the folded position, the first and second pairs of legs extend side-by-side along said bottom face of the crossbeam, and a first locking device connecting one side of one of the legs of at least one of the pairs of legs to the crossbeam in order to lock said pair of legs in the deployed position relative to the crossbeam.

31. A trestle according to claim 30, wherein the first locking device connects a side edge of the crossbeam to that leg of said pair that is closer to said side edge.

32. A trestle according to claim 30, wherein the first locking device comprises a scissors-type pair of links.

33. A trestle according to claim 30, wherein it further comprises a second locking device connecting one side of the other leg of said pair of legs to the crossbeam.

34. A trestle according to claim 33, wherein the second locking device comprises a scissors-type pair of links.

35. A trestle according to claim 34, wherein it further comprises a bracket that is secured to the bottom face of the crossbeam, said bracket having a first end fastened to the first locking device and a second end fastened to the second locking device.

36. A trestle according to claim 35, wherein the bracket extends transversely relative to the crossbeam and includes projecting portions that are disposed at respective ones of its first and second ends, the length of the bracket being substantially equal to the cumulative thickness of the two legs of said pair so that, in the folded position, the pair of legs is flanked by said portions of the bracket.

37. A folding trestle having a folded position and a deployed position, said trestle comprising: a crossbeam having a longitudinal dimension and a transverse dimension that define a bottom face; and first and second pairs of legs fastened to respective ones of the two opposite ends of the crossbeam, via respective ones of first and second hinge mechanisms, the hinge mechanisms enabling the legs of each of the pairs of legs to be spaced apart from each other when the trestle is in the deployed position, and to extend against each other when the trestle is in the folded position, the hinge mechanisms also enabling each of the pairs of legs to pivot about a respective axis that is transverse to the crossbeam so that, in the folded position, the pairs of legs extend under said bottom face of the crossbeam, the first and second hinge mechanisms being offset transversely relative to each other, so that, in the folded position, the first and second pairs of legs extend side-by-side along said bottom face of the crossbeam, at least one of the legs of one of the two pairs of legs having an end that is beveled so that, in the deployed position, said end comes into abutment against said bottom face of the crossbeam.

38. A trestle according to claim 37, wherein it further comprises a first locking device connecting at least one of the two pairs of legs to the crossbeam in order to lock said pair of legs in the deployed position relative to the crossbeam.

39. A trestle according to claim 38, wherein the first locking device connects one side of one of the legs of at least one of the pairs of legs to the crossbeam in order to lock said pair of legs in the deployed position relative to the crossbeam.

40. A trestle according to claim 38, wherein the first locking device comprises a scissors-type pair of links.

41. A trestle according to claim 37, wherein it further comprises a second locking device connecting one side of the other leg of said pair of legs to the crossbeam.

42. A trestle according to claim 41, wherein the second locking device comprise a scissors-type pair of links.

43. A trestle according to claim 41, wherein it further comprises a bracket that is secured to the bottom face of the crossbeam, said bracket having a first end fastened to the first locking device and a second end fastened to the second locking device.

44. A trestle according to claim 43, wherein the bracket extends transversely relative to the crossbeam and includes projecting portions that are disposed at respective ones of its first and second ends, the length of the bracket being substantially equal to the cumulative thickness of the two legs so that, in the folded position, the pair of legs is flanked by said portions of the bracket.

45. A trestle according to claim 30, wherein it further comprises at least one scissors-type pair of links for holding the legs of at least one of the pairs of legs spaced apart when the trestle is in the deployed position.

46. A trestle according to claim 30, wherein at least one of the first and second hinge mechanisms comprises first and second plates suitable for pivoting relative to each other, the first plate being fastened to the bottom face of the crossbeam while the second plate is provided with two side plates that can pivot in a plane defined by said second plate, each of the two side plates being fastened to a respective one of the two legs of said pair.

47. A trestle according to claim 46, wherein the second plate is further provided with an abutment mechanism for limiting the pivoting of the two side plates.

48. A trestle according to claim 30, wherein at least one of the first and second hinge mechanisms comprises first and second plates suitable for pivoting relative to each other, the first plate being fastened to the bottom face of the crossbeam, in that the two legs are mounted to pivot on the second plate, and in that the second plate is provided with a guide mechanism for guiding the pivoting of the two legs in the plane of the second plate.

49. A trestle according to claim 48, wherein the guide mechanism comprise two oblong slots, and in that each of the two legs is provided with a lug co-operating with a respective one of the two slots.

50. A trestle according to claim 30, wherein at least one of the first and second hinge mechanisms comprises an arm suitable for pivoting about an axis that is transverse to the crossbeam, wherein, in the deployed position, the arm is inserted into a groove provided in the bottom face of the crossbeam, while also extending longitudinally relative thereto, and wherein said hinge mechanisms further comprise two side plates to which the legs are fastened, the two side plates being suitable for pivoting about an axis extending longitudinally relative to the arm.
